(19) United States
(12) Patent Application Publication
(10) Pub. No.: US 2025/0214417 A1
(43) Pub. Date: Jul. 3, 2025

(54) EQUIPMENT FIXER

(71) Applicant: Tusas- Turk Havacilik Ve Uzay Sanayii Anonim Sirketi, Ankara (TR)

(72) Inventors: Berke Alp MIRZA, Ankara (TR); Mustafa Bahadir KARAHAN, Ankara (TR)

(73) Assignee: Tusas- Turk Havacilik Ve Uzay Sanayii Anonim Sirketi, Ankara (TR)

(21) Appl. No.: 18/963,590

(22) Filed: Nov. 28, 2024

(30) Foreign Application Priority Data
Dec. 28, 2023 (TR) 2023/019247

(51) Int. Cl. B60K 15/04; F16L 15/04

(52) U.S. Cl. CPC B60K 15/04; F16L 15/04

(57) ABSTRACT

The present invention relates to a fuel tank (Y) that contains fuel, at least one fluid (A) carried in the fuel tank (Y) by the manufacturer, at least one body (2) that is located inside or outside the fuel tank (Y) and allows fluid (A) to be carried through the openings therein, an adapter (3) having threads on its inner wall, an equipment (4) having threads on its outer wall, carrying fluid (A) and being removably mounted to the adapter (3) by means of threads, a part (5) having one end mounted to the body (2) and the other end to the adapter (3), thus allowing the adapter (3) to be mounted to the body (2), at least one gasket (6) having a cross-sectional area predetermined by the user, extending all around and providing sealing, and an interface (510) that has a cylindrical form and is located on the part (5) and through which the fluid (A) passes (FIG. 1, FIG. 4, FIG. 5).

### RELATED APPLICATIONS

This application claims the benefit of priority of Turkey Patent Application No. 2023/019247 filed on Dec. 28, 2023. The contents of the above applications are all incorporated by reference as if fully set forth herein in their entirety

### FIELD AND BACKGROUND OF THE INVENTION

The present invention relates to an equipment fixer that enables equipment with threaded connections to be mounted in a leak-proof manner.

Threaded connections can be used in systems containing fuel, such as fuel tanks. The threaded parts of equipment with threaded connections must not leak fuel. Threaded connections must be made leak-proof and corrosion-proof. At the same time, since lightness is an important factor in aircraft, equipment must be mounted in a way that ensures lightness. There are applications in the art such as using standard interface connections and placing the connection slot (insert) as an intermediate piece between threaded parts.

In the United States patent document numbered U.S. Pat. No. 8,998,270 in the state of the art, a threaded adapter is mentioned. In the invention, the threaded adapter generally has a first end and an opposite second end of a hollow cylinder. At least one end has threads for connection to a hose or fitting. The ends form the male half of the connection.

Centred upon the adaptor, a collar provides at least two faces for gripping of the adaptor by a tool. Within the adaptor, the two ends open into a smooth chamber that allows for uninterrupted fluid flow.

In the United States patent document numbered U.S. Pat. No. 5,533,764 in the state of the art, a transverse hydraulic coupling with a lipped port is mentioned. The invention discloses an improved hydraulic coupling which forms contact seals to fluidly connect a tapered port with a tube having a threaded connecting portion. The contact seals may be metal-to-metal seals, or alternatively may include a resin polymer element. The invention provides a fluid coupling for a tube which is transverse to the port, allowing for flow redirection in the coupling similar to the flow redirection in prior art “banjo” couplings.

In the United States patent document numbered U.S. Pat. No. 9,752,709 in the state of the art, a hydraulic fitting insert is mentioned. The hydraulic system includes a housing having a housing bore defined by a bore inner surface. The bore inner surface has an internal thread formed thereon and an insert having a flange formed adjacent a first end. A sealing feature formed adjacent a second end opposite the first end. A cylindrical outer surface extending between the first end and the second end. The cylindrical outer surface having an external buttress thread configured to mesh with the internal thread of the housing bore. The flange is configured to interface with the housing to provide a fluid seal.

### SUMMARY OF THE INVENTION

By means of an equipment fixer developed with the present invention, a hydraulic equipment with a male thread is fixed.

Another aim of this invention is to enable the mounting of equipment with a male thread to ensure sealing.

Another aim of this invention is to realise an equipment fixer that the manufacturer can produce in the desired dimensions without having to use standard interfaces.

Another aim of this invention is to realise the equipment fixer that companies with relatively low production capacity can produce with CNC machines with a relatively simple design.

The equipment fixer defined in the first claim and the claims dependent on this claim, which is realised to achieve the aim of the invention, ensures that the threaded equipment is mounted to the body in a leak-proof manner. The equipment fixer can be placed inside or outside the fuel tank. There is fuel in the fuel tank. The equipment fixer is located on the body. The body consists of pipe-like structures. The same or different types of fluid as the fuel are carried through the hollow cylindrical openings in the body. There is an adapter in the equipment fixer, and there is a helical thread opened on the inner wall of the adapter. Equipment is mounted to the equipment fixer. Fluid is carried horizontally and vertically through the openings in the equipment. There is a helical thread opened on the outer wall of the equipment. The equipment thread is mounted to the adapter thread by rotating it around its own axis in a removable manner. There is a part in the equipment fixer. The part is mounted to the body in a removable manner by means of a thread and can be produced as a single piece with the body. One side of the part is mounted to the body and the other side is mounted to the adapter. In this way, the part allows the adapter to be mounted to the body. The gasket has a cross-sectional area predetermined by the user and extends like a ring in a circular form and provides sealing. In one portion of the part, there is an interface in a hollow cylindrical form similar to a pipe and allows fluid to be carried through it.

Said equipment fixer comprises a lateral wall. The lateral wall is cylindrical in form and is concentric with the interface. The lateral wall diameter is larger than the interface diameter. The lateral wall surrounds the interface circumferentially. There is a slot with one end contacting the interface and the other end contacting the lateral wall. The slot extends outward from the interface and is located in a way that creates a wall thickness in the form of a flat plate. The inner wall of the slot contacts the interface and the outer wall contacts the lateral wall. There is a sealing surface that is located on the lower side of the adapter, and extends outward from the adapter, forming a surface in the form of a flat plate. The gasket is placed in the sealing slot. Then, when the adapter is mounted on the part, a portion of the gasket cross-sectional area is on the slot and the remaining portion is on the equipment, providing effective sealing for the threaded connection.

In one embodiment of the invention, the equipment fixer comprises a step section where the equipment main body diameter decreases and recesses towards its centre. There is a flat plate-shaped surface on the step. After the gasket is mounted on the sealing surface, when the adapter is mounted to the interface, a part of the gasket section corresponds to the slot and the remaining part of the section corresponds to the step. In this way, effective sealing is provided for the threaded connection.

In one embodiment of the invention, the equipment comprises a fixing groove. The groove is located on the adapter. There is a ring-shaped recess on all around the cylindrical adapter. The inner wall of the groove forms a recess in the form of an arc.

The groove can be selected in different section profiles, such as rectangular form, according to the manufacturer's preference. The sealing ring is preferably an O-ring extending in a circular cross-section area and in a circular form. The sealing ring is form-compatible with the groove. The sealing ring is mounted to the groove and provides sealing in case of fluid (A) passing through the seal and prevents the fluid (A) from leaking into the fuel tank (Y).

In one embodiment of the invention, the equipment comprises a fixing collar. The collar has an outer surface with the same geometry as the clamping profile of the assembly tool previously selected by the manufacturer. The inner wall of the holder is form compatible with the outer wall of the collar. The collar is mounted into the holder. When the collar is mounted to the holder, the inner wall of the holder and the outer wall of the collar are almost completely in contact. Thus, by means of the contact provided with geometrical scale similarity, force and moment transfer is provided between the holder and the collar. The holder prevents the collar from rotating during mounting. In this way, the holder allows the equipment to be easily fixed to the body by means of the adapter.

In one embodiment of the invention, the equipment fixer comprises a cover that is located on the upper part of the adapter, closing the inner walls of the upper part of the adapter. The upper part of the adapter is the part of the adapter that is farthest from the body. In this way, fuel flow from the upper part of the adapter to/from the fuel tank and to the outside of the fuel tank is prevented according to the area where the equipment fixer is placed.

In one embodiment of the invention, the equipment fixer comprises a fixing plate in the form of a flat plate extending outward from the body and parallel to the ground. There are multiple fixers on the fixing plate, which are located at equal angle intervals on a virtual circle predetermined by the manufacturer, ensuring that the body, adapter and equipment are securely fixed to the ground. The equipment fixer is mounted on the ground, and the reaction forces and moments are transferred from the ground to the fixer by means of the fixers, and then to the body.

In one embodiment of the invention, the equipment fixer preferably comprises a fixer with a nut plate.

In one embodiment of the invention, the equipment fixer comprises a female thread, which is a hollow cylinder in shape and is opened in a helical form on the inner wall of the adapter at the bottom. There is a male thread, which is a helical thread, opened in a helical form on the outer wall from the step part of the equipment to the top of the step. The male thread is mounted to the female thread in a removable manner by rotating it around its own axis. In this way, the equipment is mounted to the adapter.

In one embodiment of the invention, the equipment fixer comprises a sealing surface, groove, part and gasket on both sides of the adapter, which are the bottom and top. The collar is preferably located in the middle part of the adapter. In the alternative embodiment in which the pipe is mounted from the top of the adapter, a part can be mounted on the top of the adapter. A second part is mounted on the top of the adapter, and the pipe is mounted on the second part. The second part is mounted on the adapter from the end of the adapter that is farthest from the body. In this way, the pipe is mounted on the adapter from the top of the adapter via the second part. By mounting the part on the top of the adapter, it is possible to mount the secondary sealing ring and gasket between the part and the top of the adapter. In the alternative design mentioned, the fluid is carried in two-way flow, upwards and downwards, within the body. The sealing surface, groove, part and gasket are located in two pieces at almost equal distances from the collar. The part is mounted to the adapter from both ends with opposite openings. In the alternative design mentioned, two-way fluid transfer is provided from the body upwards and downwards. Upward fluid transfer is carried out by the fluid passing through the pipe.

In one embodiment of the invention, the equipment fixer comprises a gasket with the same surface area and dimensions as the sealing surface. Adhesion of the gasket to the sealing surface is ensured by using adhesive between the gasket and the sealing surface.

In one embodiment of the invention, the equipment fixer comprises equipment manufactured from steel material and an adapter manufactured from steel material. In alternative applications, equipment manufactured from aluminium material and an adapter manufactured from aluminium material can be used. The equipment and the adapter are preferably manufactured from the same material, ensuring that the equipment and the adapter are galvanically compatible and eliminating the risk of corrosion.

In one embodiment of the invention, the equipment fixer comprises a sealing ring where the inner wall of the sealing ring is in almost complete surface contact with the inner wall of the groove. The outer wall of the sealing ring is in almost complete surface contact with the inner wall of the lateral wall. The sealing ring is compressed between the lateral wall and the groove and has undergone elastic deformation, almost completely closing the gap between the sealing ring and the lateral wall. In this way, effective sealing is provided.

### BRIEF DESCRIPTION OF THE SEVERAL VIEWS OF THE DRAWING(S)

The equipment fixer realised to achieve the aim of the present invention is shown in the mounted figures, and of these figures;

FIG. 1 shows the perspective view of an equipment fixer.

FIG. 2 shows the perspective views of the adapter and part.

FIG. 3 shows the exploded mounting and perspective view of the adapter, sealing ring, and gasket.

FIG. 4 shows the exploded mounting view of the adapter and equipment fixer when the sealing ring and gasket are mounted to the adapter.

FIG. 5 shows the exploded mounting view of the equipment and equipment fixer.

FIG. 6 shows the exploded mounting view of the equipment and equipment fixer from another viewing angle.

FIG. 7 shows the front view of the equipment, adapter, sealing ring, and gasket.

FIG. 8 shows the front sectional view of an equipment fixer.

FIG. 9 shows the front sectional view of an alternative embodiment of an equipment fixer.

The parts in the figures are numbered one by one and the equivalents of these numbers are given below.
1. Equipment Fixer
2. Body
3. Adapter
   310. Sealing Surface
   320. Groove
   330. Collar
   340. Cover
   350. Female Thread
4. Equipment
   410. Step
   420. Male Thread
5. Part
   510. Interface
   520. Lateral Wall
   530. Slot
   540. Holder
6. Gasket
7. Sealing Ring
8. Fixing Plate
9. Fixer
10. Pipe
(Y) Fuel Tank
(A) Fluid

### DESCRIPTION OF SPECIFIC EMBODIMENTS OF THE INVENTION

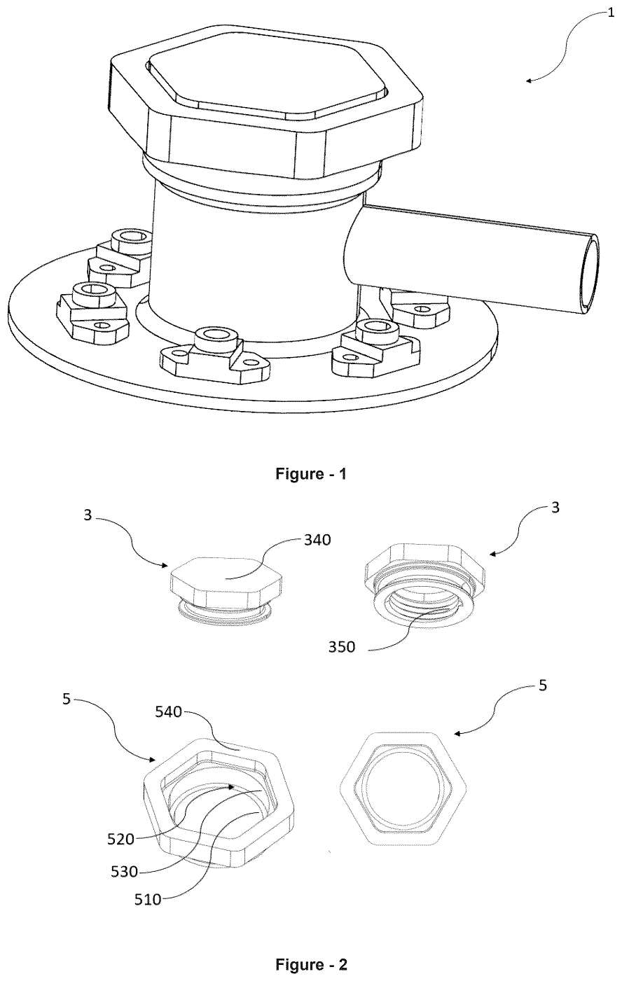

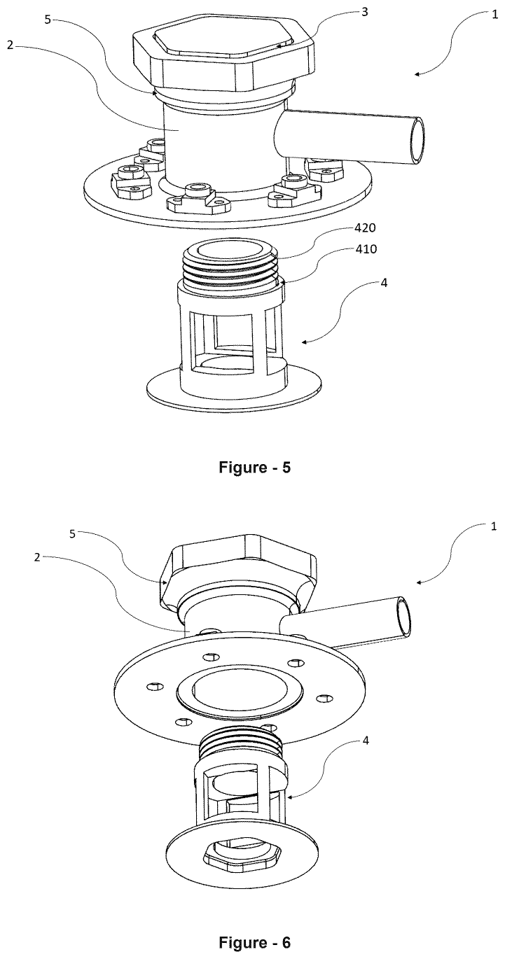

The equipment fixer (1) comprises a fuel tank (Y) that contains fuel, at least one fluid (A) carried in the fuel tank (Y) by the manufacturer, at least one body (2) that is located inside or outside the fuel tank (Y) and allows fluid (A) to be carried through the openings therein, an adapter (3) having threads on its inner wall, an equipment (4) having threads on its outer wall, carrying fluid (A) and being removably mounted to the adapter (3) by means of threads, a part (5) having one end mounted to the body (2) and the other end to the adapter (3), thus allowing the adapter (3) to be mounted to the body (2), at least one gasket (6) having a cross-sectional area predetermined by the user, extending all around and providing sealing, and an interface (510) that has a cylindrical form and is located on the part (5) and through which the fluid (A) passes (FIG. 1, FIG. 4, FIG. 5).

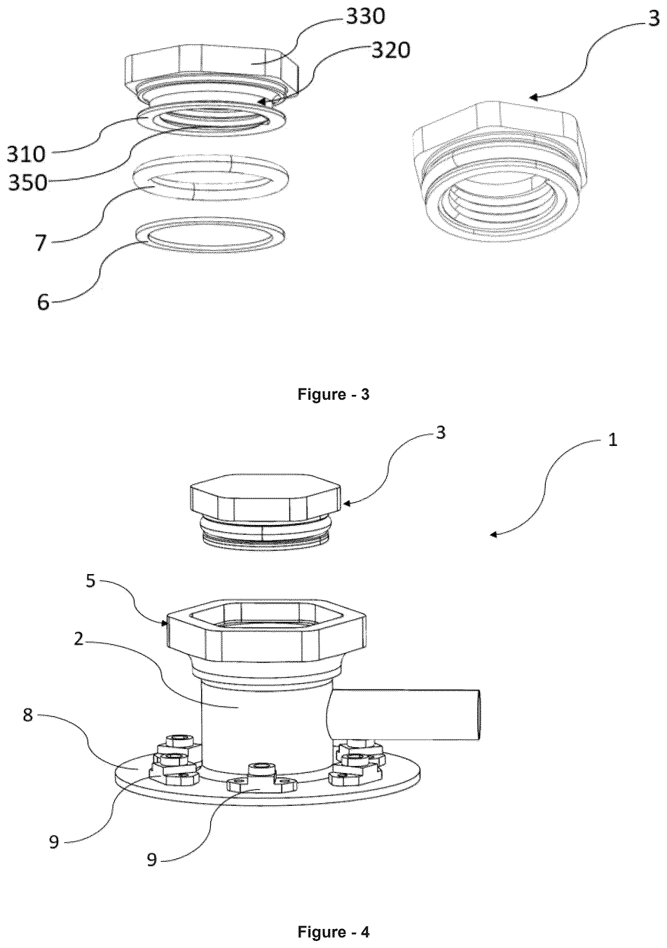

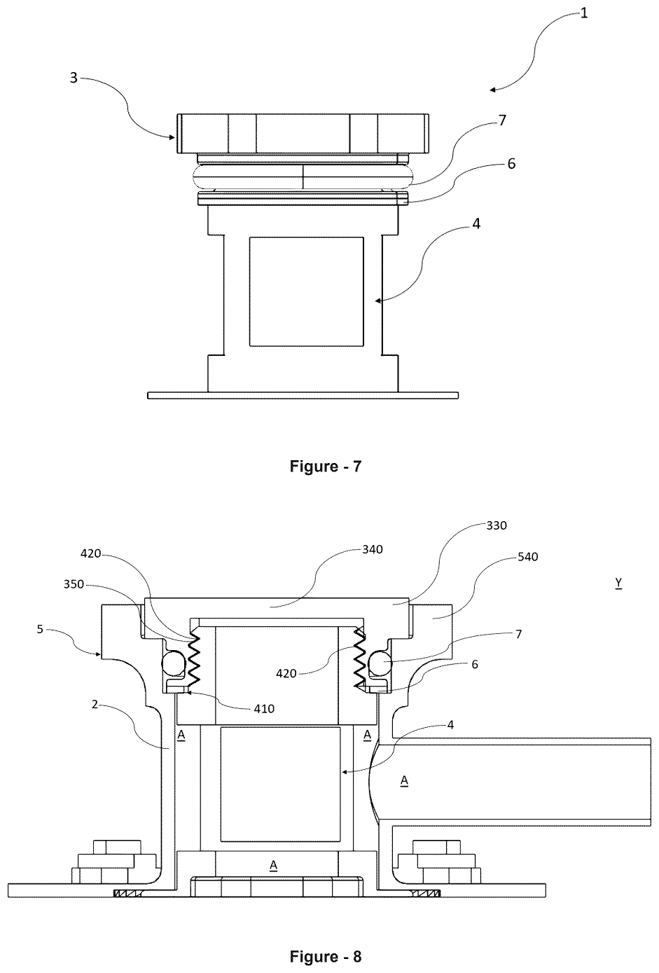

The equipment fixer (1) which is the subject of the invention comprises a lateral wall (520) that is cylindrical in shape and has a diameter larger than the interface (510) diameter and surrounds the interface (510), a slot (530) that is located in a flange form between the interface (510) and the lateral wall (520), the inner wall of which contacts the interface (510) and the outer wall of which contacts the lateral wall (520), a sealing surface (310) that is located at the end of the adapter (3) facing the body (2) and extends outwards from the adapter (3) in a flange form, and a gasket (6) that is located on the sealing surface (310), one part of which is positioned on the slot (530) and the other part on the equipment (4), providing sealing for the threaded connection (FIG. 1, FIG. 2, FIG. 3, FIG. 7, FIG. 8).

In areas where sealing is required, there is a possibility of fuel, hydraulic, air, etc. leaking through the threads of threaded equipment (4) mounted. In order to provide sealing in threaded connections, standard connection equipment (4) such as “AS5202 boss type” can be used. However, in such connection equipment (4), the equipment (4) to be mounted must be designed compatibly as in the example of AS4395 hydraulic connection. In cases where a connection that requires contact between two galvanically incompatible materials such as steel and aluminium is required, coatings that will extend the life of corrosion-resistant materials such as cadmium or zinc-nickel can be preferred to prevent corrosion of the materials. In case these coatings come into contact with fuel, the coatings can dissolve and this area becomes vulnerable to corrosion. In this case, the life of the equipment (4) reduces significantly. In cases where the equipment (4) threads in the fuel tank (Y) are steel and the adapter (3) threads are aluminium, since there is an O-ring type sealing ring (7) in between in the AS5202 standard connection, fuel is prevented from passing to the area where the female thread (350) and male thread (420) come into contact. However, in the areas where the adapter (3) and equipment (4) come into contact with each other outside the sealing ring and outside the threaded areas, galvanically incompatible material contact occurs in the area where the fuel is located. In this case, the protective coating that dissolves when the adapter (3) and equipment (4) come into contact with fuel cannot be applied. Another point to be considered in threaded connection methods is that the material strengths of the adapter (3) and equipment (4) with female thread (350) and male thread (420) to be mounted together must be the same or similar. If there is a relatively large difference between the material strengths of the adapter (3) and the equipment (4), the threads of the adapter (3) or equipment (4) with higher strength may deform the threads of the adapter (3) or equipment (4) with lower strength during mounting. As a result, the adapter (3) and equipment (4) may become unable to be mounted together. This situation may result in the adapter (3) and equipment (4) not being able to be used again. For example, if the threads of the high strength steel equipment (4) and the lower strength aluminium adapter (3) engage, the male thread (420) may deform the female thread (350) over time. In order to prevent this situation in the mounting of the male thread (420) made of steel material, it may be preferred that the adapter (3), part (5) and body (2) to be mounted are made entirely of steel; however, this situation may result in serious weight increases for the equipment fixer (1). In order to prevent this situation, the adapter (3) to which the steel equipment (4) will be mounted is made of aluminium or similar materials. However, as mentioned, in order to prevent deformation as a result of frequent demounting and mounting of the male thread (420) and female thread (350), a spring-shaped steel thread in a spiral structure called the connection slot is placed on the aluminium adapter (3). As long as this thread is not deformed, it does not need to be demounted. When the aforementioned spiral threads are used, there is a risk of galvanic corrosion between the thread and the aluminium adapter (3) with which it comes into contact. In order to prevent this, protective coatings such as cadmium or zinc-nickel are applied to the steel equipment (4). However, these coatings can dissolve when they come into contact with fuel. In order for the mentioned dissolution not to occur, the threaded area must remain in the fuel-free area. In addition, the connection slot is usually in standard sizes and can be found as standard up to one and a half inches. Values above this size can usually be made specially for companies. In this case, it takes time to find a company with the properties to do this and since the made insert is non-standard, it is much more expensive. There is a fuel tank (Y) on the aircraft. There is fuel in the fuel tank (Y). Fuel or another type of fluid (A) determined by the manufacturer is carried from the body (2) that is located in the fuel tank (Y) and has openings in it. The male thread (420) on the outer wall of the equipment (4) is mounted to the adapter (3) that has a female thread (350) on its inner wall by rotating it around its own axis in a removable manner. The part (5) can be integral with the body (2) and can be mounted to the body (2) in a removable manner by means of threads. The part (5) is mounted to the body (2) and the adapter (3) is mounted to the part (5), thus the adapter (3) is mounted to the body (2) by means of the part (5). The gasket (6) provides sealing and preferably has a rectangular section. The gasket (6) is rectangular in section and extends all around in a circular form. The interface (510) in a hollow cylindrical form is located in the part (5) that is almost cylindrical in shape, closest to the centre, and allows fluid (A) to pass through it (FIG. 1, FIG. 5, FIG. 6).

The equipment fixer (1) serves as an intermediate connection element in the mounting of the steel threaded equipment (4) in connection elements that do not fit into standard connection elements such as boss type to the aluminium part (5). At the same time, in cases where the connection slot does not have standard dimensions, for companies that do not have insert production capacity, it can be produced and used in a shorter time on CNC machines. In addition, since it is more convenient to mount the steel threaded equipment (4) to the adapter (3) made of steel material in order not to deform the threads of the adapter (3), the part and the body (2) to be mounted (5) are made entirely of steel material and are lightweight. In addition, the steel-aluminium material contact is provided in the fuel-free area, allowing the application of coatings such as cadmium, which have the risk of dissolution in contact with fuel on the steel, extending the galvanic life of the equipment (4) and the adapter (3). There is a lateral wall (520) in cylindrical form, that is larger in diameter than the interface (510), and is located concentrically with the interface (510). The lateral wall (520) surrounds the interface (510), and the slot (530) is located in the wall section between the lateral wall (520) and the interface (510). The sealing surface (310) is located on the part of the adapter (3) facing the body (2) and is in the form of an extension from the adapter (3). The gasket (6) is mounted on the sealing surface (310). After the gasket (6) and the sealing ring (7) are mounted on the adapter (3), when the lower mounting consisting of the adapter (3), the gasket (6) and the sealing ring (7) are mounted on the part (5), one part of the gasket (6) is on the slot (530) and the other part is on the step (410). Thus, the fluid (A) located in the area between the interface (510), step (410) and the sealing surface (310) is directly met by the gasket (6) and provides effective sealing (FIG. 1, FIG. 2, FIG. 3, FIG. 7, FIG. 8).

In one embodiment of the invention, the equipment fixer (1) comprises a step (410) that is located on the equipment (4), and is the part where the diameter of the equipment (4) decreases, and a gasket (6), one part of which is positioned on the slot (530) and the other part on the step (410), providing effective sealing for the threaded connection. There is a step (410) part of the equipment (4) that has a smaller diameter than the main body diameter. The step (410) part makes a recess in the form of a flange surface from the main body diameter of the equipment (4) towards the centre of the equipment (4). There is a male thread (420) from the aforementioned step (410) part up to the end point of the equipment (4). The step (410) serves as the surface on which the gasket (6) will partially sit. In the event that fluid (A) leaks into the space between the step and the slot (530), the gasket (6) partially sitting on the slot (530) and partially on the step (410) ensures that the gasket (6) directly faces the fluid (A) and provides effective sealing (FIG. 5, FIG. 8).

In one embodiment of the invention, the equipment fixer (1) comprises at least one groove (320) on the adapter (3), which is a channel all around, and at least one sealing ring (7) in the form of a circular ring, which is fitted into the groove (320) and provides sealing. The sealing ring is preferably an O-ring. The groove (320) is preferably located on the adapter (3) as a recess in the form of a spring, all around. The groove (320) ensures that the sealing ring (7) remains fixed when it is mounted, facilitating the mounting of the sealing ring (7). The sealing ring (7) is used to contribute to the sealing provided by the gasket (6). In addition, the relatively simple design of the groove (320) and the sealing ring (7) allows the adapter (3) to be produced on CNC production machines for auxiliary industry companies with limited production capabilities. In case of damage to the adapter (3), the adapter (3) can be produced quickly, contributing to the operational readiness of the aircraft (FIG. 3, FIG. 4, FIG. 7, FIG. 8).

In one embodiment of the invention, the equipment fixer (1) comprises a collar (330) that is located on the adapter (3), is form compatible with the assembly tool and is the outer wall of the adaptor (3), and a holder (540) that is located as an extension all around on the part (5), has an inner wall which is form-compatible with the collar (330), and into which the collar (330) is mounted, enabling the equipment (4) to be fixed to the body (2) by means of the adapter (3). In this way, the inner wall of the holder (540) is almost completely in contact with the outer wall of the collar (330) in a form-compatible manner, ensuring the fixation of the adapter (3) by means of the geometrical harmony. The collar (330) is preferably hexagonal in form (FIG. 2, FIG. 4, FIG. 8).

In one embodiment of the invention, the equipment fixer (1) comprises at least one cover (340) that creates structural integrity between the cylindrical walls of the adapter (3) facing each other, preventing fuel flow from the adapter (3) to the fuel tank (Y). The cover (340) is located in a way that creates a wall thickness at the farthest part of the adapter (3) to the body (2). The cover (340) is manufactured as a single piece with the adapter (3). The cover (340) closes the adapter (3) from the side farthest from the body (2), preventing fluid (A) from passing through the adapter (3) (FIG. 2, FIG. 4, FIG. 8).

In one embodiment of the invention, the equipment fixer (1) comprises at least one fixing plate (8) extending outward from the body (2) in a flange form, and multiple fixers (9) that are located all around the fixing plate (8) at intervals predetermined by the manufacturer, ensuring the fixing of the body (2), adapter (3) and equipment (4). The fixing plate (8) is preferably welded to the body (2). According to the forces to which the equipment fixer (1) will be exposed, the fixers (9) are positioned on the fixing plate (8) in a way that they are located on certain equal angle intervals on the circle with a radius predetermined by the manufacturer. In this way, each of the fixers (9) is exposed to almost equal stress. The fluid (A) can only move one way from the equipment (4) to the fixing plate (8). The part (5) is fixed by means of the body (2) and the fixers (9) (FIG. 1, FIG. 4).

In one embodiment of the invention, the equipment fixer (1) comprises a fixer (9) with a nut plate. The nut plate provides easy and effective mounting with access from one side. The equipment fixer (1) is fixed on the stable ground by means of the fixers (9) (FIG. 1, FIG. 4).

In one embodiment of the invention, the equipment fixer (1) comprises a female thread (350) that is located on the inner wall of the hollow cylindrical part on the adapter (3), and is the thread located at the end of the adapter (3) facing the body (2), and a male thread (420) that is located on the equipment (4), is the thread located on the outer surface of the equipment (4), and is mounted removably the female thread (350) by rotating, enabling the equipment (4) to be mounted on the adapter (3). The connection of the equipment (4) and the adapter (3) to each other is provided by removably mounting the male thread (420) to the female thread (350) by rotating it around its own axis. The mounting process by applying torque is provided by the technician rotating the equipment (4) from the side close to the fixer (9) by means of the assembly tool. The female thread (350) and the male thread (420) are produced from standard threads extending in a helical form. When the male thread (420) is mounted on the female thread (350), there is no need for the technician to hold the adapter (3) stable, the adapter (3) is held stable by means of the collar (330) (FIG. 2, FIG. 5, FIG. 8).

In one embodiment of the invention, the equipment fixer (1) comprises the adapter (3) in which the sealing surface (310), groove (320), part (5) and gasket (6) are located mirror symmetrically with respect to the collar (330), the part (5) that is mounted to the adapter (3) from its two ends with mutual openings, providing sealing, and a pipe (10) that is mounted to the part (5) located on the farthest side of the adapter (3) from the body (2), providing bidirectional fluid (A) transfer from the body (2). The part (5) and the gasket (6) that are located mirror symmetrically with respect to the collar (330) provide sealing on both sides of the adapter (3) with mutual openings. In the area between the equipment (4), adapter (3) and the inner wall of the body (2), the gasket (6) directly meets the fluid (A) and provides effective sealing. In the area between the adapter (3) and the pipe (10) on the side of the adapter (3) away from the body (2), the gasket (6) prevents the fluid (A) from passing to the part (5), while the sealing ring (7) is positioned between the adapter (3) and the part (5) and provides effective sealing.

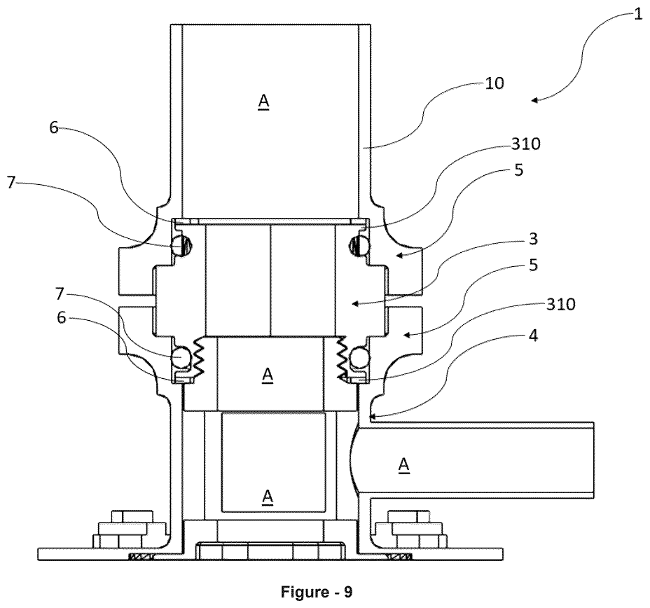

The sealing ring (7) contributes to sealing by being positioned between the pipe (10) and the adapter (3) on the side of the adapter (3) away from the body (2). The pipe (10) is mounted to the adapter (3) by mounting the part (5) to the adapter (3) from the farthest side of the adapter (3) to the body (2). The part (5) is located between the adapter (3) and the pipe (10). In cases where it is desired to transport the fluid (A) from the equipment (4) via two different flow lines, the fluid (A) can be transported bidirectionally from the body (2) to another point by mounting the pipe (10) to the part (4) and the part (4) to the adapter (FIG. 9).

In one embodiment of the invention, the equipment fixer (1) comprises a gasket (6) that is in the same geometry as the sealing surface (310) and is mounted to the sealing surface (310) by means of an adhesive method. The adhesive method ensures that the gasket (6) adheres easily to the sealing surface (310) and remains rigid on the sealing surface (310) (FIG. 3, FIG. 7, FIG. 8).

In one embodiment of the invention, the equipment fixer (1) comprises an adapter (3) and equipment (4) made of a material that is galvanically compatible with each other. In cases where the equipment (4) must be selected as a steel material, it is possible to select the adapter (3) as a steel material in addition to the equipment (4). In this way, the male thread (420) and female thread (350), which are the threads mounted to each other, do not corrode since they are galvanically compatible materials. Since the male thread (420) and female thread (350) are made of steel, which is a hard material, the threads are not damaged in case of frequent demounting and mounting and their life is long. In addition, the relatively small adapter (3) is made of steel material with high density, but since the part (5) and body (2) can be made of aluminium material, which has a lower density than steel, the equipment fixer (1) is made lightweight (FIG. 8).

In one embodiment of the invention, the equipment fixer (1) comprises a sealing ring (7) that is compressed by almost completely contacting the inner wall of the groove (320) and the lateral wall (520), providing effective sealing. The sealing ring (7) is compressed and elastically deformed as it is pressed by the inner wall of the groove (320) and the lateral wall (520), providing effective sealing by almost completely closing the gap between the lateral wall (520) and the inner wall of the groove (320) (FIG. 8).

1. An equipment fixer comprising a fuel tank (Y) that contains fuel, at least one fluid (A) carried in the fuel tank (Y) by the manufacturer, at least one body that is located inside or outside the fuel tank (Y) and allows fluid (A) to be carried through the openings therein, an adapter having threads on its inner wall, an equipment having threads on its outer wall, carrying fluid (A) and being removably mounted to the adapter by means of threads, a part having one end mounted to the body and the other end to the adapter, thus allowing the adapter to be mounted to the body, at least one gasket having a cross-sectional area predetermined by the user, extending all around and providing sealing, and an interface that has a cylindrical form and is located on the part and through which the fluid (A) passes, wherein a lateral wall that is cylindrical in shape and has a diameter larger than the interface diameter and surrounds the interface, a slot that is located in a flange form between the interface and the lateral wall, the inner wall of which contacts the interface and the outer wall of which contacts the lateral wall, a sealing surface that is located at the end of the adapter facing the body and extends outwards from the adapter in a flange form, and a gasket that is located on the sealing surface, one part of which is positioned on the slot and the other part on the equipment, providing sealing for the threaded connection

2. An equipment fixer according to claim 1, wherein a step that is located on the equipment, and is the part where the diameter of the equipment decreases, and a gasket, one part of which is positioned on the slot and the other part on the step, providing effective sealing for the threaded connection.

3. An equipment fixer according to claim 1, wherein at least one groove on the adapter, which is a channel all around, and at least one sealing ring in the form of a circular ring, which is fitted into the groove and provides sealing.

4. An equipment fixer according to claim 1, wherein a collar that is located on the adapter, is form compatible with the assembly tool and is the outer wall of the adaptor, and a holder that is located as an extension all around on the part, has an inner wall which is form-compatible with the collar, and into which the collar is mounted, enabling the equipment to be fixed to the body by means of the adapter.

5. An equipment fixer according to claim 1, wherein at least one cover that creates structural integrity between the cylindrical walls of the adapter facing each other, preventing fuel flow from the adapter to the fuel tank (Y).

6. An equipment fixer according to claim 1, wherein at least one fixing plate extending outward from the body in a flange form, and multiple fixers that are located all around the fixing plate at intervals predetermined by the manufacturer, ensuring the fixing of the body, adapter and equipment.

7. An equipment fixer according to claim 6, wherein the fixer with nut plate.

8. An equipment fixer according to claim 1, wherein a female thread that is located on the inner wall of the hollow cylindrical part on the adapter, and is the thread located at the end of the adapter facing the body, and a male thread that is located on the equipment, is the thread located on the outer surface of the equipment, and is mounted removably the female thread by rotating, enabling the equipment to be mounted on the adapter.

9. An equipment fixer according to claim 1, wherein the adapter in which the sealing surface, groove, part and gasket are located mirror symmetrically with respect to the collar, the part that is mounted to the adapter from its two ends with mutual openings, providing sealing, and a pipe that is mounted to the part located on the farthest side of the adapter from the body, providing bidirectional fluid (A) transfer from the body.

10. An equipment fixer according to claim 1, wherein a gasket that is in the same geometry as the sealing surface and is mounted to the sealing surface by means of an adhesive method.

11. An equipment fixer according to claim 1, wherein the adapter and the equipment made of a material that is galvanically compatible with each other.

12. An equipment fixer according to claim 1, wherein the sealing ring that is compressed by almost completely contacting the inner wall of the groove and the lateral wall, providing effective sealing.
